(19) United States
(12) Patent Application Publication
(10) Pub. No.: US 2010/0020846 A1
(43) Pub. Date: Jan. 28, 2010

(54) Irreversible Coolness Indicator

(76) Inventors: Michael Kagan, Jerusalem (IL); Vladimir Mirsky, Sinzing (DE); Otto Wolfbeis, Regensburg (DE)

Correspondence Address: CHOATE, HALL & STEWART LLP, TWO INTERNATIONAL PLACE, BOSTON, MA, 02110, US

(21) Appl. No.: 12/304,678

(22) PCT Filed: Jun. 14, 2007
(86) PCT No.: PCT/IL2007/000719

§ 371 Date: Sep. 17, 2009

(30) Foreign Application Priority Data
Jun. 19, 2006 (IL) 176396
Jun. 10, 2007 (IL) 183801

(51) Int. Cl. G01K 11/12; G01K 1/00

(52) U.S. Cl. 374/141; 374/161; 374/162; 374/E11.018; 977/955; 374/E01.001

(57) ABSTRACT

The invention provides a temperature-threshold indicator device 10 comprising a sealed housing 12 having at least one surface 14 which is transparent and containing a suspension of inorganic nanoparticles 18 suspended in a liquid medium wherein the suspension undergoes an irreversible detectible change in optical characteristics upon freezing of the liquid medium due to aggregation of the nanoparticles, and wherein the device is provided a with means for association thereof with a product whereby the temperature-threshold indicator device 10 serves to determine whether the product has been exposed to an environment of predetermined coldness.

### BACKGROUND OF THE INVENTION

1. Field of the Invention

The present invention relates to an irreversible temperature-threshold indicator with an inherent color which will detect whether an article has been subjected to a cooling cycle. More particularly, the present invention relates to an encapsulated visible nano-dispersion of inorganic solid particles in a liquid medium which becomes irreversibly destabilized upon freezing and which thereafter provides a telltale visual indication if the temperature of the dispersion rises through its freeze/thaw temperature.

The term temperature-threshold indicator as used herein, is intended to denote an indicator which shows if the temperature has gone below a predetermined coolness value or threshold, such as 0° C., −2° C. or +2° C., as once the temperature falls below said threshold, the change mechanism is automatically and irreversibly activated.

2. Description of the Prior Art

As discussed in U.S. Pat. No. 4,148,748, which represents the closest prior art of which applicant is aware, many products, when subjected to cooling beyond a certain temperature threshold, deteriorate rapidly to the point where they are seriously affected by loss of quality, loss of activity or are rendered totally unusable. A vivid example of such deterioration is soluble vaccines. In a 1996 report published in the Bulletin of the World Health Organization (74, 391-397) it was disclosed that 99% of a shipment of Hepatitis B vaccines were rendered useless because of a freeze/thaw cycle that occurred somewhere in the supply chain. Such de-activation of the vaccine usually goes undetected thereby resulting in zero protection for injected adults and children. Other examples where cooling beyond the freezing point has a detrimental effect include, foods such as mayonnaise, fabric softeners, latex products such as paints, concrete modifiers, laboratory supplies. Biological samples such as whole blood, insulin and the like can be seriously affected or lost when subjected to freezing conditions, and this is also true for high value biotechnology drugs containing proteins, enzymes or peptides. Therefore, it is important to the seller, buyer and end user of such products that some indicator means be provided which will signal a change in products caused by cooling conditions.

A number of products are currently available for indicating a freeze/thaw cycle. Cold Chain Technologies (Holliston, Mass.) markets a product by 3M called Freeze Watch®. A colored liquid, presumably water, is held in a breakable vial which is broken by the expansion of the water upon freezing. Upon thawing the colored liquid stains an absorbent strip. The price for such a device is advertised as $2.63 each. A similar device is ColdMark® which is composed of a delicate capillary tube attached to a small bulb. When passing through a freeze/thaw cycle the liquid in the bulb changes color. The price for such a product is listed as $2.97 each. A further product made available by Cold Chain Tech. (Holliston, Mass.) is Koolwatch® which is a disposable electronic temperature monitoring device listed at $6.00 a unit. A further device is provided by TelaTemp Corp (Fullerton, Calif.) that markets ColdSnap®. This device has a ±2° C. accuracy bimetallic sensing element that snaps at its critical cold temperature, permanently turning an indicating window from clear into bright red. The listed price per unit is $3.80.

U.S. Pat. No. 4,148,748 discloses a means for detecting a freeze/thaw cycle by the encapsulation of an opaque colloidal dispersion of organic solid particles such as latexes suspended in a liquid medium. After having been frozen and thawed the suspension coagulates to form a non-flowing waxy gel leaving a clear liquid. The organic colloidal dispersion has no inherent color and appears as a white opaque cloudy liquid. Therefore, it presents serious problems in observing a change in state due to a freeze/thaw cycle.

Similarly U.S. Pat. No. 6,957,623 discloses a means for detecting a freeze/thaw cycle by the encapsulation of a mixture of water, a nucleating agent (ice nucleating active (INA) microorganisms), latex, and stabilizers which is translucent prior to freezing and opaque after thawing but likewise has no inherent color and therefore presents serious problems in clearly indicating a change in state due to a freeze/thaw cycle.

In contradistinction, the inorganic nanoparticles of the present invention have a very distinctive, inherent, visible color, such as a red-wine color for suspended nanoparticles of colloidal gold and a distinctive yellow color for suspended nanoparticles of colloidal silver.

A further example known in the prior art of a thermosensitive indicator is illustrated by U.S. Pat. No. 2,971,852, as mentioned and distinguished in U.S. Pat. No. 4,148,748. This indicator utilizes an emulsion of oil in water, water in oil or oil in oil to record if a temperature rise above its freezing point has occurred since the emulsion will break and separate into two phases after it has thawed. The emulsion indicator differs from the present invention not only in that it utilizes an emulsion rather than a suspension of inorganic solid nanoparticles having an inherent color when suspended in a liquid media, but also in that it can only be reliably used as a thaw indicator rather than as a freeze indicator since emulsions are generally unstable in the liquid state at normal storage temperatures and will quickly separate into two phases. Therefore, the emulsion indicator has only a short shelf life above freezing temperatures after being made and must be quickly transformed to its frozen state and used as a thaw indicator to be accurate and reliable.

Accordingly, it is an object of the present invention to provide an improved irreversible temperature-threshold indicator adapted to indicate whether an article has been exposed to an environment of predetermined coldness. Another object of the present invention is to provide an indicator with an inherent color that will easily indicate by loss of said inherent color whether an object that such a detector is attached to has undergone a cooling beyond a predetermined temperature. Another object of the present invention is to provide an indicator that can be easily and economically produced at a sales price low enough for use at the unit level. It is a further object of the present invention to provide for an indicator that can be stored for an extended period of time at normal temperatures without loss of effectiveness. A further object of the present invention is to provide an indicator which can be easily utilized, easily read and is reliable and accurate. A further object of the present invention is to provide the means of detecting a freeze/thaw cycle at various freezing temperatures in particular temperatures close to zero degrees centigrade. Other objects of the present invention will be apparent from the following specification, drawings and claims.

### SUMMARY

In general, the present invention provides an irreversible indicator of coolness which will detect whether an article has been subjected to temperatures below a predetermined threshold of coolness such as a freeze/thaw cycle comprising an encapsulated nano-dispersion of inorganic solid particles in a liquid medium where such a nano-dispersion of inorganic solid particles in a liquid medium has an inherent color which, upon freezing provides a telltale visual sign if the temperature of the dispersion rises through its freeze/thaw temperature. After the nano-dispersion of inorganic solid particles has once been frozen to trigger its irreversible destabilization and has been thawed, the resulting larger particles effects a loss of the initial inherent color leaving a substantially clear liquid.

Thus according to the present invention there is now provided a temperature-threshold indicator device comprising a sealed housing having at least one surface which is transparent and containing a suspension of inorganic nanoparticles suspended in a liquid medium wherein said suspension undergoes an irreversible detectible change in optical characteristics upon freezing of the liquid medium due to aggregation of the nanoparticles, and wherein said device is provided with means for association thereof with a product package whereby said temperature-threshold indicator device serves to determine whether said product has been exposed to an environment of predetermined coldness for said product package.

Inherent coloring of nano-suspensions of inorganic materials occurs particular in highly conductive metals such as gold, silver, copper, platinum, alkaline metals and alloys thereof, and in quantum dots. A preferred embodiment is a nano-suspension of metallic gold in water. It is well known that a suspension of nano-particles of metallic gold has an inherent color often described as red-wine color. This inherent red-wine color of gold nanoparticles is due to excitation of plasmon resonance and subsequent absorption of light around 520 nm. For a nano-suspension of silver the absorption is at about 410 nm endowing the solution with an inherent yellow color. Such a nano-suspension can be readily formed by electrolysis techniques or more preferably by the reduction of a gold salt. An example of such a reductive process is given by the reaction between hydrogen tetrachloroaurate and sodium citrate as is well known in the art. By means of controlling the temperature of the reaction and the concentrations of the reagents it is possible to determine the size of the metallic particles and the concentration of the suspension. Typical average particle size is from 5 nm to 100 nm. In the preferred embodiment the average particle size is 10-50 nm. Concentrations range from 1 ppm to 1000 ppm. In the preferred embodiment the concentration of gold particles ranges from 10 ppm to 150 ppm.

Thus in a preferred embodiment of the present invention said inorganic nanoparticles are formed from highly conductive materials.

In especially preferred embodiments of the present invention said highly conductive materials are selected from the group consisting of gold, silver, copper, platinum, alkaline metals, alloys and mixtures thereof.

As is known, one of the interesting aspects of metal nanoparticles, is that their optical properties depend strongly upon the particle size and shape. Thus, it is known that metals with free electrons, such as gold, silver, copper and alkaline metals possess plasmon resonance in the visible spectrum which gives rise to intense colors. On the other hand, there are available nanoparticles of inorganic metals which have a thin oxide layer thereon and which possess a characterizing black color, which coated particles can be maintained in a suspension with use of appropriate additives and which therefore, theoretically, can also be used in the present invention. Such inorganic metal nanoparticles include iron, nickel, manganese, cobalt, copper and silver and are formed by methods such as gas phase condensation as provided by QuantumSphere, Inc. Santa Ana, Calif.

In a further embodiment, the inherent color of a suspension of quantum dots in water is utilized as a temperature-threshold indicator. Quantum dots are also known as semiconductor nanocrystals or artificial atoms, and are semiconductor crystals the size of which are in the range of just a few nanometers. They contain anywhere from 100 to 1,000 atoms and range from 2 to 10 nanometers, or 10 to 50 atoms, in diameter. The discrete energy levels present in such materials cause them to be colored and have strong florescent signals. While the material which makes up a quantum dot is significant, more significant in terms of coloration is the size. The larger the dot, the redder (the more towards the red end of the spectrum) the fluorescence. The smaller the dot, the bluer (the more towards the blue end) it is. The coloration is directly related to the energy levels of the quantum dot. Quantitatively speaking, the bandgap energy that determines the energy (and hence color) of the fluoresced light is inversely proportional to the square of the size of the quantum dot. An example of such a quantum dot is nano-crystals of cadmium selenium that emits in the 465 nm to 640 nm band for particle sizes between 1.9 nm and 6.7 nm. When a suspension of such nano-particles in a liquid medium undergoes a freeze/thaw cycle an irreversible loss of the inherent color and fluorescent emission signals is experienced.

Thus, in preferred embodiments of the present invention, said inorganic nanoparticles are formed from semi-conducting materials.

In especially preferred embodiments of the present invention, said semi-conducting materials are known as quantum dots and have absorption and fluorescence in the visual optical range.

Preferably, said quantum dots are coated with at least one organic compound to protect the same.

The encapsulation of the nano-suspension can be accomplished by placing it in a glass vial, blister pack such as commonly used to package individual pharmaceutical tablets, a plastic pouch, or other like containers. In use, the freeze-indicator is best placed firmly against the product being monitored inside its shipping container, if possible. In this way, the indicator will not freeze until just before the product itself starts to freeze since the product will act as a thermal sink for the indicator.

In other preferred embodiments of the present invention said inorganic nanoparticles are formed by a wet chemical process.

In especially preferred embodiments of the present invention the resulting suspension of said inorganic nanoparticles formed by the said wet chemical process is purified from destabilizing contaminants by a filtration process such as dialysis or diafiltration.

In especially preferred embodiments of the present invention the resulting suspension of said inorganic nanoparticles formed by the said wet chemical process is stabilized by the addition of a stabilizer such as a surfactant.

In especially preferred embodiments of the present invention the said stabilizer is sodium dodecylsulfate (SDS).

In further preferred embodiments of the present invention said inorganic nanoparticles are formed by an electrochemical process.

In yet other preferred embodiments of the present invention said inorganic nanoparticles are formed by a gas phase condensation process.

In especially preferred embodiments of the present invention said inorganic nanoparticles consist of a combination of metals and metal oxides.

In preferred embodiments of the present invention, said liquid medium is deuterium oxide.

In other preferred embodiments of the present invention, said liquid medium is water or combinations of water and deuterium oxide.

In especially preferred embodiments of the present invention said liquid medium includes at least one additive for modifying the freezing point of said liquid medium and especially preferred additives for this purpose are ethylene glycols including poly(ethylene glycol).

In especially preferred embodiments of the present invention said liquid medium includes at least one additive for encouraging ice nucleation activity of said liquid medium and an especially preferred additive for this purpose is INA⁺ proteins from the bacteria Pseudomonas syringae (31a) available commercially as Snomax provided by YorkSnow inc., New York.

In other preferred embodiments of the present invention said liquid medium is an organic solvent, and in especially preferred embodiment said solvent is toluene.

In especially preferred embodiments of the present invention said inorganic nanoparticles are formed of colloidal gold which in deuterium oxide exhibits a homogeneous rose red color and upon freezing and thawing aggregates to a grey In other preferred embodiments of the present invention said inorganic nanoparticles are formed of colloidal silver which in deuterium oxide exhibits a homogeneous yellow color and which upon freezing and thawing aggregates to a grey agglomerate leaving the deuterium oxide colorless.

In some preferred embodiments of the present invention said irreversible detectible change in optical characteristics upon freezing of the liquid medium is manifested in said liquid becoming substantially colorless as a result of the aggregation of said colored nanoparticles.

In other preferred embodiments of the present invention said irreversible detectible change in optical characteristics upon freezing of the liquid medium is manifested in said liquid becoming substantially colorless as a result of the aggregation of said colored nanoparticles and revealing indicia or a different color provided in said indicator opposite said transparent surface.

According to the present invention there is also provided a temperature-threshold indicator device as defined in combination with a product package containing a product, the cooling of which product below a specific temperature has a detrimental effect thereon.

According to the present invention the said product package has at least one hydrophilic layer that is in direct contact with the said liquid medium containing the said colored nanoparticles.

In some preferred embodiments of the present invention there is provided a temperature-threshold device as defined, wherein said device is in the form of a concentric tube formed from spaced apart inner and outer tubular walls, such as that described hereinafter with reference to FIGS. 5A and 5B, wherein said inner wall surrounds an area containing a product, the cooling of which below a specific temperature has a detrimental effect thereon.

In such a preferred embodiment, preferably an outer surface of said concentric tube is transparent and an area between said two walls forming said concentric tube contains a suspension of inorganic nanoparticles suspended in a liquid medium.

As stated, the temperature-threshold indicator devices of the present invention provide a very distinctive, and visible color change as opposed to the opaque colloidal dispersion of organic solid particles described in U.S. Pat. No. 4,148,748 and it is believed that the fact that such opaque colloids formed from organic solid particles do not have a strong distinctive inherent color, has resulted in the fact that even though said patent issued to Dow more than 25 years ago indicators based thereon have not been found, to the best of our knowledge, on the market, despite the long-felt need, as described above, for such indicators.

According to another aspect of the present invention there is provided a hermetically sealed package having at least one transparent surface and containing a volume of inorganic nanoparticles suspended in a liquid medium, wherein said inorganic nanoparticles have an inherent visible color when suspended in said suspension and wherein said suspension undergoes an irreversible detectible change in optical characteristics upon freezing of the liquid medium due to aggregation of the nanoparticles.

In preferred embodiments of the present invention said hermetically sealed package is formed from a lower formable layer and an upper lidding layer sealed to each other and encapsulating said nanoparticle suspension.

Preferably said lower layer is opaque and preferably said opaque layer is composed of aluminum. In other preferred embodiment this aluminum layer contains polar functional groups as ice nucleation points described in patent publication number US2004249222.

In said preferred embodiment preferably said layer of aluminum has a metallic color.

In other preferred embodiments of the present invention said layer of aluminum has a co-laminated opaque plastic layer and wherein said opacity is formed from the group consisting of a white pigment, a printed icon, or a fluorescing material.

In yet another preferred embodiments of the present invention said lower layer is an opaque plastic or a transparent plastic with an opaque print.

Preferably in these preferred embodiments, said layer of opaque plastic is colored white or contains a printed icon or a fluorescing material.

In especially preferred embodiments of the present invention said lower layer is provided with an adhesive for attachment of said package to a predetermined surface.

Preferably said package has an upper layer formed of a transparent plastic.

In preferred embodiments of the present invention said hermetical seal between said upper and lower layers is achieved by lamination.

In other preferred embodiments of the present invention said hermetical seal between said upper and lower layers is achieved by welding.

In said other preferred embodiments of the present invention said welding is preferably selected from the group consisting ultra-sonic welding, high frequency welding, and high temperature welding.

In yet another preferred embodiment of the present invention said hermetical seal between said upper and lower layers is achieved by ring sealing.

Preferably said transparent upper layer comprises a combination of materials which create a high barrier to evaporation of the liquid medium.

In some preferred embodiments of the present invention said upper layer has printed information on its outer surface.

In other preferred embodiments of the present invention said upper layer is covered by a removable aluminum layer wherein said removable layer is laminated onto the upper transparent layer in a manner that creates a hermetic but peelable seal.

In some preferred embodiments of the present invention said package consists of a cavity formed in the lower layer.

In other preferred embodiments of the present invention said package consists of a cavity formed in the upper layer.

In yet another preferred embodiment of the present invention said package consists of a thin cavity between a non-laminated area in the lower layer and a non-laminated area in the upper layer.

Preferably said thin cavity is flexible and label-like.

In a most preferred embodiment of the present invention said package consists of lower layer of aluminum, an upper layer of high-barrier transparent plastic, a cavity of 0.15 ml that is formed in the upper layer, containing 0.1 ml of a suspension of 100 ppm in water of nanoparticles of gold of average size 20-50 nm, a print on the upper layer, a means of attaching said package to a container and wherein the color of said suspension is rose red which permanently and irreversibly disappears upon a freeze/thaw cycle and wherein said package has a shelf-life of greater than two years.

In preferred embodiments of the present invention as a result of a freeze/thaw cycle and the resulting loss of color in the liquid medium, a printed symbol on the inside of the package opposite the transparent surface is revealed.

In some preferred embodiments of the present invention, said symbol is visibly detectable.

In other preferred embodiments of the present invention said symbol is detectable via a florescence emission.

In especially preferred embodiments of the present invention said package is flexible.

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 shows a side view of a temperature-threshold indicator device with a nano-suspension held in a blister between two high barrier materials of which at least one is transparent.

FIG. 2 shows a side view of a temperature-threshold indicator device with a nano-suspension held in a narrow cavity between two high barrier materials of which at least one is transparent.

FIGS. 3A and 3B show aerial views of a temperature-threshold indicator device with a transparent window revealing the state of a temperature-threshold indicator before and after a freeze/thaw cycle.

FIG. 4 shows a hollow bead filled with a temperature-threshold indicator liquid placed inside a vessel containing a low temperature sensitive substance.

FIGS. 5A and 5B show a perspective and a top view of double-walled container with the outer chamber containing a temperature-threshold liquid.

### DETAILED DESCRIPTION OF THE INVENTION

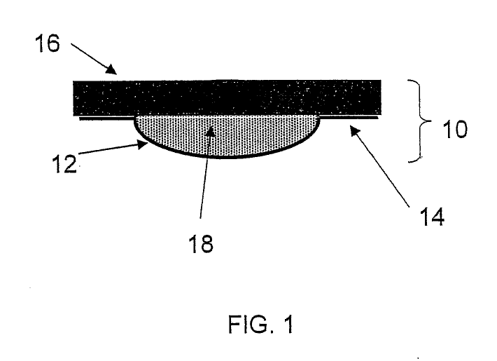

More specifically referring to FIG. 1 there is shown an irreversible temperature-threshold indicator 10 having a housing in the form of a blister 12 formed from a lower formable layer 14 and an upper lidding layer 16 encapsulating an inherently colored nano-suspension 18 of inorganic nanoparticles 17 suspended in a liquid 19.

For the irreversible temperature-threshold indicator 10 to be applicable as a warning device giving a clear indication that the contents of an article, such as vaccine in a vaccine vial, has undergone a freeze/thaw cycle, it is necessary that it displays a clear and visible indication that a freeze/thaw cycle has occurred and that the lifetime of the irreversible temperature-threshold indicator 10 is comparable to that of the shelf life of the vaccine sample in the said vial. The shelf life of regular vaccines such as Hepatitis B is between two and three years at storage temperatures between 2° C. and 10° C. Therefore the active material in the irreversible temperature-threshold indicator 10, namely the nano-suspension 16, in this preferred embodiment and by way of example only, being a nano-suspension of gold, must be stable over a comparative period of time. There are at least two causes that shorten the lifetime of the irreversible temperature-threshold indicator 10, one being the aggregation and resulting loss of inherent color of the nano-suspension, and the other being the loss of the liquid medium due to evaporation and migration through the encapsulation materials.

In the preferred embodiment the lower formable layer 14 is a high-barrier, transparent thermo-formable plastic from which the blister 12 is thermally formed by methods known to one skilled in the art such as vacuum forming. Such high-barrier, transparent thermo-formable plastics include multilayer composite plastic materials containing a barrier layer of polybutylene terephthalate such as described in U.S. Pat. No. 6,517,918, copolymer combinations of such plastics that include high-density polyethylene (PE-HD), polyamides (PA), poly(ethylene-co-vinyl alcohol) (EVOH), PVC, polyvinylidene chloride, and non-plastics such as ceramics and silicon.

The upper lidding layer 16 consists of an impermeable foil such as aluminum with a suitable structure to allow for a strong, hermetic seal with the lower formable layer 14. Such a seal can be performed by hot lamination techniques and by welding techniques as is well known in the art. An example of such an impermeable lidding structure is an outer layer of PETP film, a polyurethane adhesive, aluminum foil and a heat seal lacquer such as a vinyl base lacquer that allows for hot lamination to the lower formable layer 14. A further example of a lidding structure is an outer layer of a PETP film, a polyurethane adhesive, aluminum foil; and an inner layer of a weldable plastic such as polypropylene, PVC, and polyethylene that allows for a welded seal to a compatible lower formable layer 14. Such a welded seal is performed by methods that include high-frequency welding, ring sealing, and ultra-sonic welding. Such a lidding foil is provided by Alcan Inc., Montreal, Canada.

The volume of the blister in the preferred embodiment is between 0.05 ml and 1.5 ml.

It is understood that in this preferred embodiment the irreversible temperature-threshold indicator 10 is inverted for use with a pressure sensitive adhesive (not shown) located on the outer side of the upper lidding layer 16 for the purpose of attachment to an article, such as the lid of a vaccine vial, and with viewing of the inherently colored nano-suspension taking place through the body of the blister.

In another embodiment the irreversible temperature-threshold indicator 10 consists of a blister 12 formed in a lower formable layer 14 of an impermeable foil such as aluminum with a suitable structure to allow for blister formation and a strong, hermetic seal with an upper lidding layer 16. The blister 12 is formed in the lower formable layer 14 by pressure using techniques known to one skilled in the art such as cold forming. An example such an impermeable formable structure is an outer layer of oPA (Nylon 6), a polyurethane adhesive, a polyurethane primer lacquer, an aluminum foil, a polyurethane adhesive and a rigid layer of PVC. Such forming foil is provided by Alcan, Montreal, Canada.

In this embodiment the upper lidding layer 16 is a high-barrier, hydrophilic transparent plastic such as described hereinabove and also includes such materials as non-formable, super-high barrier transparent coatings, such as alternating layers of polymer and ceramic thin films, developed for such humidity sensitive materials as OLEDS and is provided by Vitex Systems Inc., San Jose, Calif. and Alcan (Ceramis), Montreal, Canada.

In the preferred embodiment the nano-suspension 18 consists of nano-particles of gold produced by the reduction of hydrogen tetrachloroaurate by sodium citrate, as known per se in the art, the liquid medium being deuterium dioxide. A typical ratio of reactants is a 100 ml of 2 mM of aurate with 10 ml mixture of 4% DEG with 4% citrate at 1:1 v/v. Consistent with the goal of providing for an irreversible temperature-threshold indicator 10 with a long life-time as described hereinabove, is the necessity to ensure the stability of the nano-suspension and to prevent spontaneous aggregation of the nano-suspension and consequential loss of its inherent color and functionality. Increasing the stability of the nano-suspension is achieved in at least two ways; one—by adjusting the physical composition of the nanosuspension, and two—by adjusting the chemical composition of the nanosuspension.

It has been found that the stability of the solution is enhanced by controlling the particle size of the nanoparticles and the concentration of the suspension in the liquid medium. It is possible to determine the size of the metallic particles and the concentration of the suspension by means of controlling the temperature of the reaction and the concentrations of the reagents. In the preferred embodiment the average gold particle size is 20-50 nm and the concentration of gold particles is 100 ppm. It has been found that the stability of the nanosuspension 18 is enhanced by removing by-products of the nanosuspension 18 forming reaction. This is accomplished by means known in the art including dialysis filtration and diafiltration of all dissolved materials. Other methods of increasing stability include increasing the electrical charge on the surface of the nano-particles. Such methods include adsorption of highly charged chemical groups to the nano-particles. Such groups include ionic surfactants and thiolated compounds. To this end, upon completion of the synthesis described hereinabove sodium dodecylsulfate (SDS) is added to the final concentration at a ratio of 0.00005 mg/ml.

The phenomenon of super-cooling is well known in the art. Water can remain in the liquid state at temperatures well below zero degrees centigrade. For temperature thresholds corresponding to zero or near-to-zero degrees centigrade the preferred embodiment the liquid medium of the temperature-threshold indicator is deuterium oxide whose freezing point is 3.82° C. The use of deuterium dioxide plus ice nucleation proteins from the Pseudomonas syringae (31a) bacteria plus hydrophilic surfaces in the packaging material allows the temperature-threshold indicator to freeze at −1° C. after 20 minutes. To this end, upon completion of the synthesis described hereinabove a concentration of Snomax is added to the final concentration at a ration of 0.016 mg/ml

In a further embodiment the temperature of freezing point of the liquid medium, namely deuterium oxide, is lowered by the addition water and of temperature-lowering substances such as ethylene glycols in the eventuality that the sample to be monitored freezes at temperatures lower than that of zero degrees centigrade.

In yet a further embodiment the liquid medium of the nanosuspension 18 in the irreversible temperature-threshold indicator 10 is toluene. Synthesis of nanogold in an organic liquid medium such as toluene, is known per se in the art.

In yet a further embodiment the nanosuspension 18 is a dispersion of quantum dots as provided by Evident Technologies, Troy, N.Y. Such quantum dots include such inorganic composites as cadmium selenide and cadmium telenide and have inherent colors that are dependent upon the size of nanoparticles. Thus in such an embodiment a nano-suspension 18 in pure water of quantum dots with a CdSe core and a ZnS shell quantum dot of average size 3.5 nm will have an absorption of around 530 nm and will appear red in color. Upon undergoing a freeze/thaw cycle the nanosuspension 18 irreversibly aggregates causing a tell-tale disappearance of color. Furthermore the quantum dots have strong fluorescent emission signals which disappear following a freeze/thaw cycle.

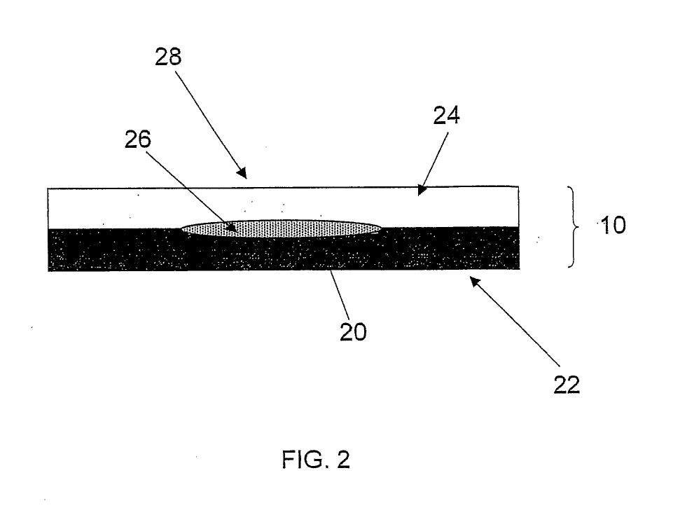

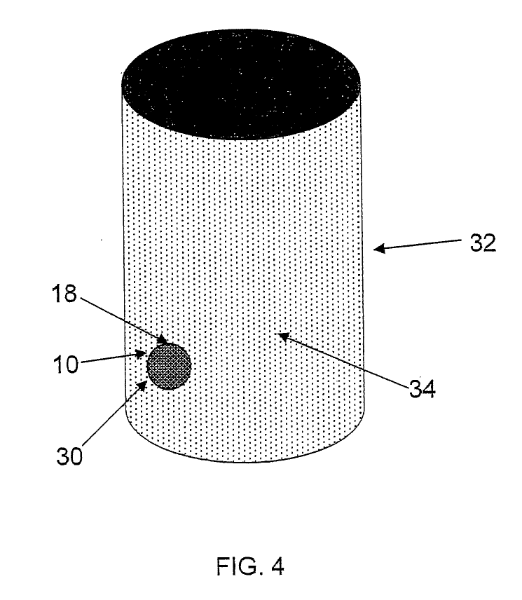

Reference is now made to FIG. 2 in which a further embodiment of the irreversible temperature-threshold indicator 10 is described where a cavity 20 is formed between the lower layer 22 and the upper layer 24. In such an embodiment the nano-suspension 18 is a shallow volume of liquid of a volume of between 0.05 ml and 1 ml and a depth of 0.1 ml to 1 ml. The lower layer 22 and the upper layer 24 comprise similar materials to those described hereinabove (FIG. 1) namely aluminum and high barrier plastics. A print 28 is situated on the outer surface of the upper layer 24 as shown more clearly in FIG. 4. Such an embodiment being without a thermo or pressure formed layer (see FIG. 1) is flexible and pouch-like and is applied to a surface such as a vaccine vial in a manner similar to the application of a label with adhesives (not shown) applied to the lower layer 22.

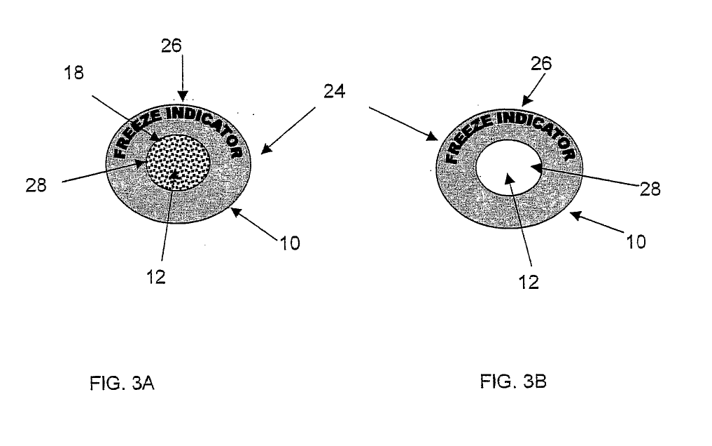

Reference is now made to aerial views of an irreversible temperature-threshold indicator 10 in FIG. 3A and FIG. 3B in which a blister 12 is formed according to the preferred embodiment described hereinabove. The upper layer 24 is a high-barrier, hydrophilic transparent formable plastic from which the blister 12 is formed. A print 26 covers the area around the blister 12 in such a way as to leave a transparent window through which the inherent color of the nanosuspension 18 (FIG. 3A) is viewed. In the preferred embodiment the nanosuspension is an aqueous suspension of red colored nano-gold. Following a freeze/thaw cycle the red colored nano-suspension 18 of gold disappears (FIG. 3B) as the gold aggregates forming a minute quantity of grey agglomerate and allowing the inner surface of the lower layer (16 in FIG. 1) to become visible.

The color of the inner surface of the lower layer (16 in FIG. 1) can be chosen to enhance the detectability of the aggregation of the nanogold due to a freeze/thaw cycle. By way of example, when the inner surface of the lower layer (16 in FIG. 1) is metallic then the inherent red color of the nanogold is darkened due to the increase in the absorption of the incident light through the colored nanosuspension 18 by doubling the apparent path-length; a colored inner surface of the lower layer can be chosen to increase the contrast between the pre-frozen state of the inherently colored nanosuspension 18 and the post-frozen state of the clear liquid medium; a fluorescently doped inner surface of the lower layer undetectable prior to a freeze/thaw cycle becomes visibly fluorescent when irradiated with UV light after the nanogold has aggregated due to a freeze/thaw cycle.

In a further embodiment shown in FIG. 4 an irreversible temperture-threshold indicator 10 is made of an insoluble container 30. Examples of such an insoluble container 30 include hollow glass beads, small transparent plastic tubes, and transparent plastic spheres. Hermetically closed within the insoluble container 30 is an inherently colored nanosuspension 18. The insoluble container 30 is constructed of materials that allow it to be compatibly placed inside a vessel 32 such as a vial containing a freeze-sensitive component 34 such as a vaccine dose. When the freeze-sensitive component 34 undergoes a freeze/thaw cycle the inherent color of the nanosuspension 18 disappears leaving the insoluble container 30 colorless.

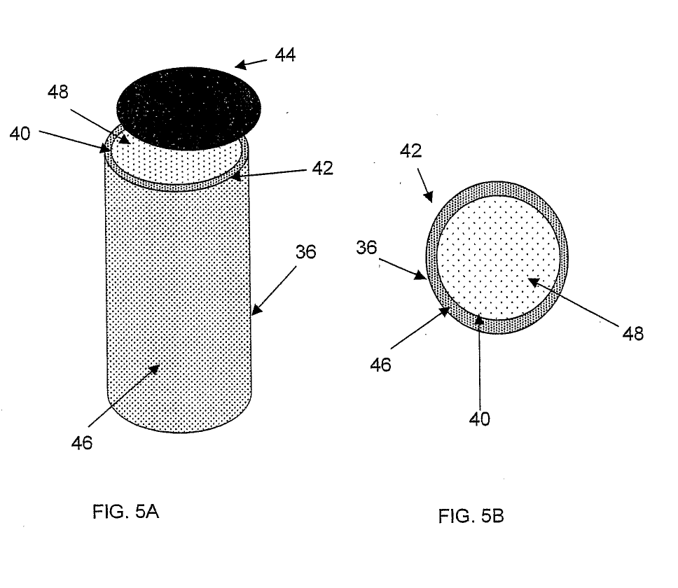

A further embodiment of the general principle is shown in FIG. 5A and FIG. 5B in which a transparent vessel 36 such as a vaccine vial is constructed of an inner wall 40, an outer wall 42 and a lid 44. An inherently colored nano-solution 46 such as a suspension of nano-gold in water fills the volume between the inner wall 40 and the outer wall 42. The volume defined by the inner wall 40 contains a freeze sensitive component 48 such as a vaccine. The nano-solution 46 and the freeze sensitive component 48 are sealed inside the vessel 36 by means of the lid 44. The lid is held in place by means known in the art. When the freeze sensitive component 48 undergoes a freeze/thaw cycle the inherent color of the nano-suspension 46 disappears leaving the vessel 36 colorless.

It is understood that the scope of this invention is not limited by the means of encapsulating the colloidal dispersion or by the materials used to form the encapsulating container. Thus, while certain representative embodiments and details have been shown for the purpose of illustrating the invention, it will be apparent to those skilled in the art that various changes and modifications can be made therein without departing from the spirit and the scope of the invention.

1-59. (canceled)

60. A temperature-threshold indicator device comprising a sealed housing having at least one surface which is transparent and containing a suspension of inherently colored inorganic nanoparticles suspended in a liquid medium wherein said suspension undergoes an irreversible detectable change in optical characteristics upon freezing of the liquid medium due to aggregation of the nanoparticles; characterised in that said device has means for association thereof with a product, and that the suspension was formed by a reaction in the liquid medium and by-products of the nano-suspension forming reaction have been removed, whereby said temperature-threshold indicator device serves to determine whether said product has been exposed to an environment of predetermined coldness.

61. A temperature-threshold indicator according to claim 60, wherein the temperature threshold is zero degrees and the liquid medium is deuterium oxide.

62. A temperature-threshold indicator according to claim 60, wherein said inorganic nanoparticles are selected from the group of highly conductive metals consisting of gold, silver, mixtures and alloys thereof.

63. A temperature-threshold indicator according to claim 60, wherein said inorganic nanoparticles are formed from semi-conducting materials known as quantum dots and have absorption and fluorescence in the visual optical range.

64. A temperature-threshold indicator according to claim 60, wherein said liquid medium includes at least one additive for modifying the freezing point of said liquid medium said additive being an ice nucleating additive.

65. A temperature-threshold indicator according to claim 60, wherein said liquid medium includes at least one additive for modifying the stability of said inorganic nanoparticles.

66. A temperature-threshold indicator, according to claim 65, wherein said additive is a surfactant.

67. A temperature-threshold indicator according to claim 60, wherein said liquid medium is purified by dialysis filtration.

68. A temperature-threshold indicator according to claim 60, wherein said liquid medium is purified by diafiltration filtration.

69. A temperature-threshold indicator according to claim 60, wherein said inorganic-nanoparticles are formed of colloidal gold which in said liquid medium exhibits an apparent homogeneous rose red color and upon freezing and thawing aggregates to a grey agglomerate leaving the said liquid medium substantially colorless.

70. A temperature-threshold indicator device according to claim 60 in association with a product package containing a product, the exposure of which to coldness has a detrimental effect thereon.

71. A hermetically sealed package having at least one transparent surface and containing a volume of inorganic nanoparticles suspended in a liquid medium, wherein said liquid medium is deuterium oxide, wherein said inorganic nanoparticles have an inherent visible color when suspended in said suspension and wherein said suspension undergoes an irreversible detectible change in optical characteristics upon freezing of the liquid medium due to aggregation of the nanoparticles.

72. A hermetically sealed package according to claim 71 formed from a lower layer and an upper layer heat sealed to each other and encapsulating said nanoparticle suspension.

73. A hermetically sealed package according to claim 71 wherein said lower layer is provided with an adhesive for attachment of said package to a predetermined surface.

74. A hermetically sealed package according to claim 71 wherein said transparent upper layer comprises a combination of materials which create a high barrier to evaporation of the liquid medium.

75. A hermetically sealed package according to claim 71 wherein said package consists of a lower layer and an upper layer of high-barrier to evaporation transparent polymeric packaging material heat sealed to form a cavity, wherein said cavity contains a purified and stabilized suspension of 50-150 ppm of nanoparticles of gold in deuterium oxide of average size 20 nm, 0.00005 mg/ml sodium dodecyl sulfate, a small quantity of ice-nucleating additive, a print on said upper layer, a viewing window within said print, a means of attaching said package to a container and wherein the color of said suspension is rose red which permanently and irreversibly disappears upon a freeze/thaw cycle and wherein said package has a shelf-life of greater two years.

76. The device of claim 60 containing 0.05 to 1-5 ml of the suspension.

77. The package of claim 72 containing 0.05 to 1.5 ml of the suspension.
